(19) United States
(12) Patent Application Publication
(10) Pub. No.: US 2024/0427099 A1
(43) Pub. Date: Dec. 26, 2024

(54) OVERMOLD FOR OPTICAL FIBER DISTRIBUTION CABLE AND RELATED METHOD AND SYSTEM

(71) Applicant: CORNING RESEARCH & DEVELOPMENT CORPORATION, Corning, NY (US)

(72) Inventors: Sergey Vladimirovich Chernykh, Berlin (DE); Reginald Roberts, Taylorsville, NC (US)

(21) Appl. No.: 18/822,763

(22) Filed: Sep. 3, 2024

Related U.S. Application Data
(63) Continuation of application No. PCT/US2023/014313, filed on Mar. 2, 2023.
(60) Provisional application No. 63/317,148, filed on Mar. 7, 2022.

(51) Int. Cl. G02B 6/44

(52) U.S. Cl. CPC G02B 6/443; G02B 6/4479

(57) ABSTRACT

Embodiments of the disclosure relate to an optical fiber distribution cable. The cable includes a central member extending along a longitudinal axis of the cable. A plurality of subunits is stranded around the central member in at least one layer, including an outermost layer of subunits. An overmold is formed around the outermost layer of subunits adjacent to at least one branch point. The overmold is made of a thermoplastic material. Each subunit has a subunit jacket. The subunit jackets of the outermost layer define an outermost surface of the cable. A first subunit branches away from the cable at the at least one branch point. The thermoplastic material of the overmold has a melting temperature at least 10° C. less than a melting temperature of the subunit jackets. Further, a bonding force between the overmold and the subunit jackets is at least 600 lbsf.

### CROSS-REFERENCE TO RELATED APPLICATIONS

This application is a continuation of International Patent Application No. PCT/US2023/014313 filed on Mar. 2, 2023, which claims the benefit of priority of U.S. Provisional Application No. 63/317,148 filed on Mar. 7, 2022, the content of which is relied upon and incorporated herein by reference in its entirety.

### BACKGROUND

The disclosure relates generally to an optical fiber distribution cable having a plurality of branching subunits and more particularly to an overmold applied to branch points and transition regions of the optical fiber distribution cable. As optical fibers are routed through a network, they may be carried in smaller and smaller optical fiber cables. For example, a main distribution cable may include several hundreds or thousands of optical fibers, and optical fiber cables containing fewer optical fibers may branch off of the main distribution cable at various points along the length of the main distribution cable. At such branching points, the branching cables may be protected with a molding material. However, such molding materials tend to be expensive, difficult to obtain in large quantities, and have a narrow range of properties, limiting customization.

### SUMMARY

According to an aspect, embodiments of the disclosure relate to an optical fiber distribution cable. The optical fiber distribution cable includes a central member extending along a longitudinal axis of the optical fiber distribution cable. A plurality of subunits is stranded around the central member in at least one layer. The at least one layer includes an outermost layer of subunits. An overmold is formed around the outermost layer of subunits adjacent to a branch point, the overmold comprising a thermoplastic material. Each subunit of the plurality of subunits has a subunit jacket. Subunit jackets of the outermost layer of subunits define an outermost surface of the optical fiber distribution cable. A first subunit branches away from the optical fiber distribution cable at the branch point. The thermoplastic material of the overmold has a first melting temperature at least 10° C. less than a second melting temperature of the subunit jackets. Further, a bonding force between the overmold and the subunit jackets of the outermost layer of subunits is at least 600 lbsf.

According to another aspect, embodiments of the disclosure relate to a method of forming an overmold over an optical fiber distribution cable. The distribution cable includes an outer layer of subunits as an outermost surface of the distribution cable. In the method, the optical fiber distribution cable is positioned in a mold adjacent to a location at which at least one subunit of the outer layer of subunits branches from the optical fiber distribution cable. The mold includes a cavity defining a cylindrical ring around the distribution cable and an inlet in fluid communication with the cavity. A thermoplastic material is injected into the cavity through the inlet. The thermoplastic material has a first melting temperature that is at least 10° C. less than a second melting temperature of subunit jackets of the outer layer of subunits. Further, the thermoplastic material has a bonding force with the subunit jackets of the outer layer that is at least 600 lbsf.

According to a further aspect, embodiments of the disclosure relate to a mold for injection molding an overmold of an optical fiber distribution cable. The mold includes a first mold half having a first half of a mold cavity, a first half of a first stepped ring section at one end of the first half of the mold cavity, and a first half of a second stepped ring section at an opposing end of the first half of the mold cavity. The mold cavity defines half of a cylindrical ring. The mold includes a second mold half having a second half of the mold cavity, a second half of the first stepped ring section at one end of the second half of the mold cavity, and a second half of the second stepped ring section at the opposing end of the second half of the mold cavity. The mold also includes a first split seal ring with a first scalloped inner surface configured to engage an outer layer of subunits of the optical fiber distribution cable. The first split seal ring is configured to be seated in the first stepped ring section. Further, the mold includes a second split seal ring with a second scalloped inner surface configured to engage the outer layer of subunits of the optical fiber distribution cable. The second split seal ring is configured to be seated in the second stepped ring section.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a cross-sectional view of an optical fiber distribution cable, according to an exemplary embodiment;

FIGS. 2-4 depict cross-sectional views of optical fiber distribution cables having from one to three layers of subunits, according to exemplary embodiments;

FIG. 5 depicts a cross-sectional view of an optical fiber subunit, according to an exemplary embodiment;

FIG. 6 depicts a cross-sectional view of an electrical conductor subunit, according to an exemplary embodiment;

FIG. 7 depicts a schematic side view of an optical fiber distribution cable, according to an exemplary embodiment;

FIGS. 8 and 9 depict exemplary embodiments of an injection molding system for forming the overmold around the distribution cable, according to an exemplary embodiment;

FIGS. 10 and 11 depict a mold for forming the overmold around the distribution cable, according to an exemplary embodiment;

FIG. 12 depicts an embodiment of an overmold formed around the distribution cable after being released from the mold, according to an exemplary embodiment;

FIGS. 13 and 14 depict split seal rings configured for use with the mold, according to exemplary embodiments;

FIG. 15 depicts an example of a finished overmold including visual branding language formed around the distribution cable, according to an exemplary embodiment;

FIG. 16 depicts a graph of dimensional change as a function of temperature for an example overmold composition as compared to typical subunit jacket materials, according to an exemplary embodiment;

FIG. 17 depicts a distribution cable having an overmold secured in a load frame to test the bonding force between the overmold and the subunit jackets, according to an exemplary embodiment;

FIG. 18 depicts a graph of the force required to separate cause failure of the distribution cable through loading of the overmold for aged and unaged samples, according to exemplary embodiments; and

FIG. 19 depicts a sample after having undergone loading to failure on the load frame, according to an exemplary embodiment.

### DETAILED DESCRIPTION

Referring generally to the figures, various embodiments of an overmold for a distribution cable and related methods and systems for forming same are provided. As will be discussed more fully below, the overmold material is a thermoplastic material that is formed around a distribution cable adjacent to points where subunits branch from the distribution cable or at points where the distribution cable transitions to an underlying layer of subunits. The overmold holds the subunits in place at the branch/transition point, maintaining the accurate positioning of the branch/transition point and the integrity of the distribution cable. To provide that function, embodiments of the overmold are designed to adhere strongly to the subunit jackets as well as withstand relevant cable temperature/humidity cycling and weathering standards. Additionally, the thermoplastic overmold material is able to be injection molded using typical industrial equipment. As compared to certain conventional thermosetting overmold materials, the cure time is much shorter, and the properties of the thermoplastic overmold material can be customized to a greater degree. Exemplary embodiments of the overmold and a method and a system of forming same will be described in greater detail below and in relation to the figures provided herewith, and these exemplary embodiments are provided by way of illustration, and not by way of limitation.

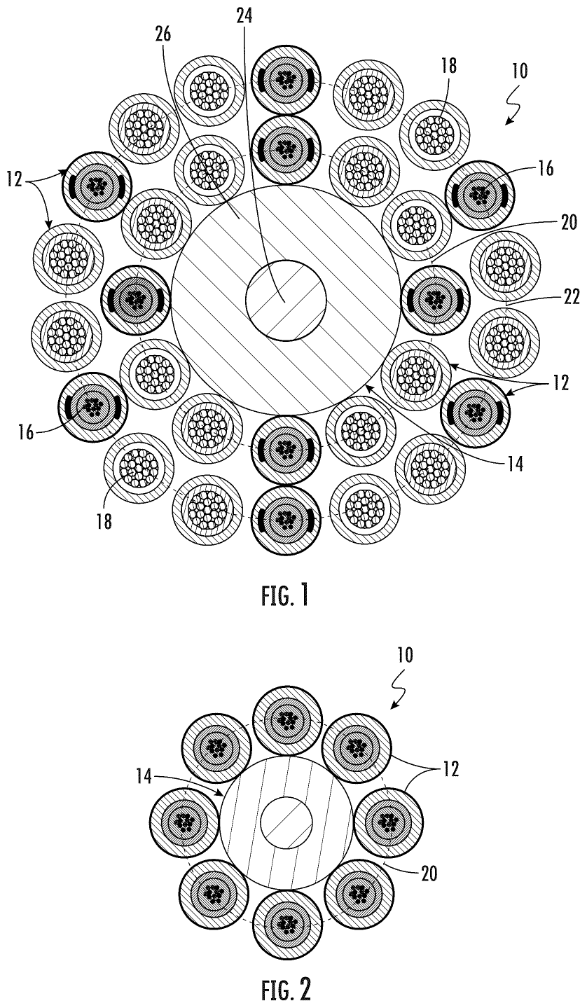

FIG. 1 depicts an embodiment of a distribution cable 10 comprising a plurality of subunits 12 stranded around a central member 14. As can be seen in FIG. 1, the plurality of subunits 12 includes optical fiber subunits 16 and electrical conductor subunits 18. In one or more embodiments, the distribution cable 10 includes only optical fiber subunits 16. In one or more other embodiments, the distribution cable 10 includes a mix of optical fiber subunits 16 and electrical conductor subunits 18. In such embodiments, the number of optical fiber subunits 16 may vary from, e.g., one to fifty-four, and the number of electrical conductor subunits 18 may vary from, e.g., zero to fifty-three. In one or more embodiments, the total number of subunits 12 stranded around the central member 14 is up to fifty-four.

As can be seen in FIG. 1, the subunits 12 are stranded around the central member 14 in one or more layers. FIG. 1 depicts a first layer 20 and a second layer 22. The number of subunits 12 in each layer 20, 22 depends on the size of the central member 14, the size of the subunits 12, and the number of layers of subunits 12 beneath a respective layer of subunits 12. In FIG. 1, the first layer 20 includes twelve subunits 12, and the second layer 22 includes eighteen subunits 12. In general, for subunits 12 of a given size, each layer of subunits 12 will include about six more subunits 12 than the layer preceding it. In contrast to other cable designs, the subunits 12 of the presently disclosed optical fiber distribution cable 10 are not surrounded by or contained within an outer jacket that forms an outer surface of the cable. Instead, the subunits 12, in particular the outermost layer of subunits 12, define the outermost surface of the optical fiber distribution cable 10. As will be discussed more fully below, the particular layer of subunits 12 defining the outermost surface of the optical fiber distribution cable 10 may change along the length of the optical fiber distribution cable 10 as subunits 12 branch off from the main body of the cable 10.

The central member 14 may be any of a variety of structures. In one or more embodiments, including the embodiment depicted in FIG. 1, the central member 14 is a central strength member having a central strength element 24 and an upjacket 26. In such embodiments, the central strength element 24 is a fiber-reinforced plastic rod (such as a glass or carbon fiber-reinforced plastic rod), a metal wire, or a plurality of tensile elements (such as yarns comprising glass fiber, carbon fiber, aramid, polyester, or ultra-high molecular weight polyethylene). Disposed around the central strength element 24 is the upjacket 26, which is formed from a polymeric material. In embodiments, the thickness of the upjacket 26 varies depending on the desired diameter of the central member 14. In one or more other embodiments, the central member 14 is one or more optical fiber cables. For example, the central member 14 may be a high fiber count optical fiber cable (e.g., containing hundreds or thousands of optical fibers), such as a Corning® RocketRibbon™ (available from Corning Incorporated, Corning, NY). In another example, the central member 14 may be, e.g., three optical fiber cables or subunits stranded together.

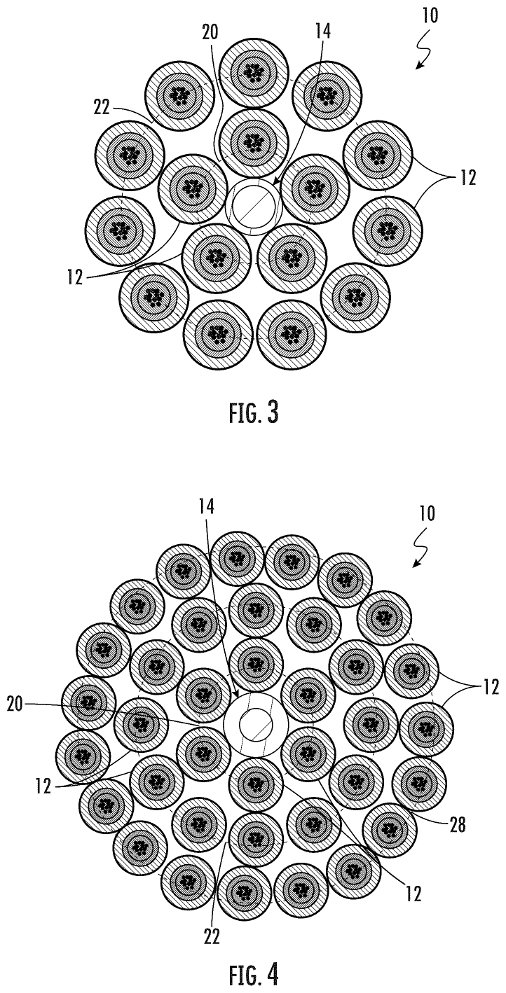

FIGS. 2-4 depict various embodiments of an optical fiber distribution cable 10. In FIG. 2, the distribution cable 10 has a single layer 20 of subunits 12, which are all depicted as optical fiber subunits 16, stranded around a central member 14. As can be seen in the embodiment of FIG. 2, the layer 20 includes eight subunits 12. In FIG. 3, the distribution cable 10 has two layers 20, 22 of subunits 12, which are all depicted as optical fiber subunits 16, stranded around a central member 14. As can be seen in the embodiment of FIG. 3, the first layer 20 includes five subunits 12. Thus, as compared to the central member 14 of FIG. 2, the central member 14 of FIG. 3 has a smaller diameter for subunits 12 of the same size. In FIG. 3, the second layer 22 includes eleven subunits 12. In FIG. 4, the distribution cable 10 has a first layer 20, a second layer 22, and a third layer 28 of subunits 12, which are all depicted as optical fiber subunits 16, stranded around a central member 14. In FIG. 4, the first layer 20 includes six subunits 12, which, for subunits 12 of the same size, means that the central member 14 is larger than the central member 14 of the embodiment depicted in FIG. 3 but smaller than the central member 14 of the embodiment depicted in FIG. 2. The second layer 22 includes twelve subunits 12, and the third layer 28 includes nineteen subunits 12. The example embodiments shown in FIGS. 2-4 are provided to demonstrate the variability in the size and construction of distribution cables 10 according the present disclosure. However, such embodiments are not limiting, and as discussed above, the type of subunits 12 and central member 14 as well as number of layers of subunits 12 can vary depending on the needs of the installation.

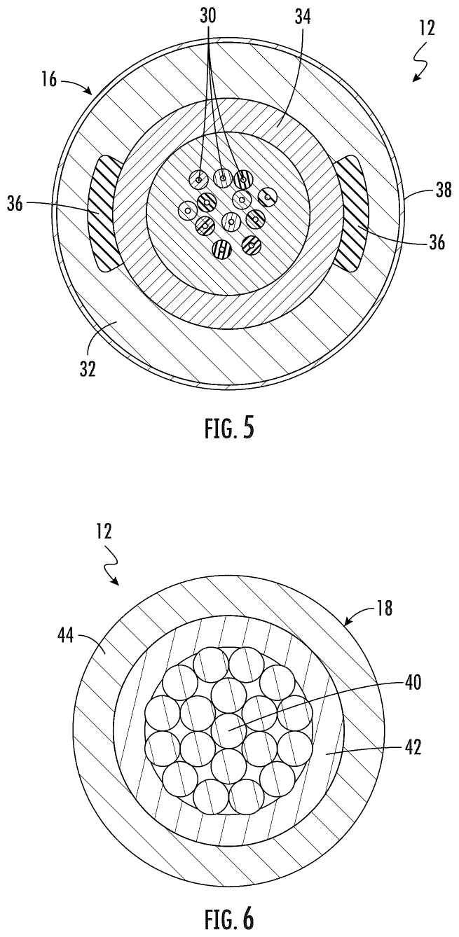

FIGS. 5 and 6 depict example embodiments of subunits 12. FIG. 5 depicts an embodiment of an optical fiber subunit 16. In general, each optical fiber subunit 16 includes one or more optical fibers 30 disposed within a subunit jacket 32. In one or more embodiments, including the embodiment depicted in FIG. 5, the optical fiber subunit 16 includes a plurality of optical fibers 30 disposed within a buffer tube 34 in a loose tube configuration. In one or more other embodiments, the optical fiber subunit 16 includes a plurality of optical fibers 30 arranged in one or more optical fiber ribbons. In still one or more other embodiments, the optical fiber subunit 16 includes a single optical fiber 30 in a tight-buffered configuration. Other configurations of optical fibers 30 within the optical fiber subunit 16 are also possible. In one or more embodiments, the optical fiber subunit 16 includes from one to twenty-four, in particular from one to twelve, optical fibers 30.

In one or more embodiments, the optical fiber subunit 16 includes one or more tensile elements 36 embedded within the subunit jacket 32 and/or extending alongside a buffer tube 34. In such embodiments, the tensile elements 36 may be yarns comprising, e.g., glass fiber, carbon fiber, aramid, polyester, or ultra-high molecular weight polyethylene, among other materials. Further, in one or more embodiments, the subunit jacket 32 may be further surrounded by a skin layer 38. In certain embodiments, the skin layer 38 may be provided to reduce the friction of the optical fiber subunit 16 for cable blowing applications. In such embodiments, the skin layer 38 may be, e.g., high-density polyethylene (HDPE). The foregoing discussion of the optical fiber subunit 16 and depiction in FIG. 5 are merely exemplary, and other configurations of the optical fiber subunit 16 are possible and should be considered to be within the scope of the present disclosure.

FIG. 6 depicts an embodiment of an electrical conductor subunit 18. As can be seen in FIG. 6, the electrical conductor subunit 18 includes a conductor core 40, which is depicted as a stranded wire. Disposed around the conductor core 40 is an insulation layer 42, and a conductor subunit jacket 44 is provided around the insulation layer 42. The electrical conductor subunit 18 transmits electrical energy along the conductor core 40 to power, e.g., installations in the optical fiber network.

The distribution cable 10 may be configured to transmit optical signals and electrical energy throughout an optical network. In this regard, the subunits 12 branch from the distribution cable 10 at various points along the length of the distribution cable 10 where it is desired to provide optical/electrical communication, such as at distribution hubs, premises, or other installations. When the distribution cable 10 is manufactured, the subunits 12 are fabricated to be a particular length to branch off or terminate along the distribution cable at a distance corresponding to the desired location to deliver optical/electrical signals in the fiber optic network. Adjacent to such a branch point, the distribution cable 10 is wrapped in an overmold. Further, after a layer of subunits 12 have branched from or terminated along the distribution cable 10, the transition to the underlying layer may be covered with an overmold.

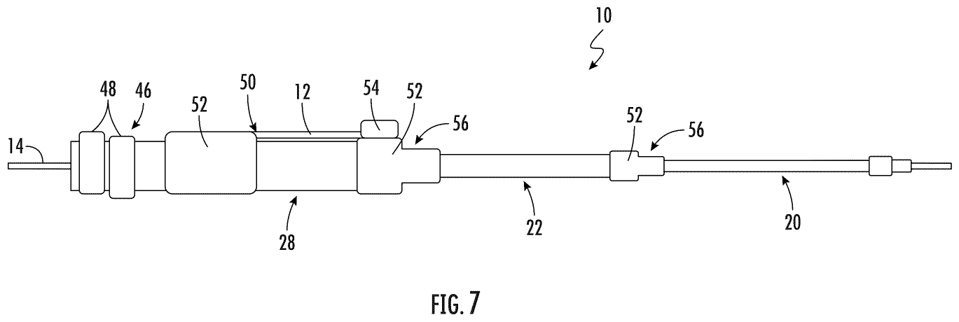

FIG. 7 depicts a schematic embodiment of a distribution cable 10 having three layers 20, 22, 28 of subunits 12 around a central member 14. As can be seen in FIG. 7, the central member 14 extends along the length of the distribution cable 10. At a first end 46 of the distribution cable 10, the subunits 12 of the third layer 28 are held in place with a one or more heat-shrink wraps 48. Such heat-shrink wraps 48 may be provided periodically along the length of the distribution cable 10 until a subunit 12 branches off from the distribution cable 10. The subunit 12 branches off from the distribution cable 10 at a branch point 50. Adjacent to the branch point 50, an overmold 52 is provided around the distribution cable 10. As shown in FIG. 7, the subunit 12 may be pre-terminated with a connector 54 (such as OptiTip® or OptiTap® connectors, available from Corning Incorporated, Corning, NY). Further, as can be seen in FIG. 7, the distribution cable 10 includes two transition points 56 where the distribution cable 10 transitions from three layers to two layers and from two layers to one layer. In one or more embodiments, the distribution cable 10 includes overmolds 52 at each transition point 56.

In one or more embodiments, each overmold 52 is formed from a thermoplastic material. In particular, the thermoplastic material is selected to have the following characteristics: low melting temperature, high melt flow rate and good processability, balance between hardness and elastic modulus, strong adherence to subunit jackets, good low temperature performance, ultraviolet and chemical resistance, and strong mechanical properties. In terms of melting temperature, the overmold material has a melting temperature that is at least 10° C., at least 15° C., at least 20° C., at least 25° C., or at least 30° C. lower than the melting temperature of the subunit jacket of the subunits 12. By having a lower melting temperature than the subunit jackets of the subunits 12, the application of the overmold 52 to the distribution cable 10 will not damage the subunits 12.

Additionally, the overmold material has a high melt flow rate. In one or more embodiments, the melt flow rate is at least 4 g/10 min at 190° C., at least 10 g/10 min at 190° C., or at least 14 g/10 min at 190° C., as measured according to ASTM D 1238-Automatically Timed Flow Rate, Procedure B (21.6 kg standard weight). The high melt flow rate improves the processability during injection molding of overmold 52 around the distribution cable 10. In particular, the high melt flow rate improves the flow of the molten polymer around the distribution cable 10 and between the subunits 12 within the injection molding apparatus.

Further, the overmold material balances hardness and elastic modulus such that the overmold material withstands deformation and external mechanical loads but is sufficiently flexible to support the tethered cable assemblies from experiencing kinking. In one or more embodiments, the overmold material has a hardness in the range of 60 to 95, in particular in the range of 85 to 88, as measured according to ASTM D2240-15 (Shore A, Instantaneous). Further, in one or more embodiments, the overmold material has an elastic modulus in the range of 70 MPa to 250 MPa, in particular in the range of 100 MPa to 150 MPa, as measured according to ASTM D638-14.

Additionally, the overmold material is designed to adhere strongly to the subunit jacket material of the subunits 12. In this way, the overmold is locked in place along the distribution cable, which keeps integrity of the stranded subunits 12. As will be discussed more fully below, the adhesion of the overmold to the subunits can be demonstrated by a pull test in which one end of a distribution cable is anchored, and a load frame pulls against the overmold until the distribution cable fails. Using such a pull test, the bonding force between the overmold 52 and the subunits 12 is at least 600 lbsf, in particular at least 700 lbsf, and more particularly at least 800 lbsf.

Additionally, the overmold should be able to pass relevant cable standards such as Telcordia Generic Requirements, including GR-20-CORE and GR-3122-CORE. The GR-20-CORE requirements relate to outside plant cables and require good impact strength and crack resistance at low temperatures as well as UV and chemical resistance. The GR-3122-CORE standard relates to factory-installed termination systems and provides information regarding the ability of an overmold material to withstand conditions that can severely damage bonding between the subunit jackets and the overmold material as heat and moisture cause material deformation and degradation which affect the bonding.

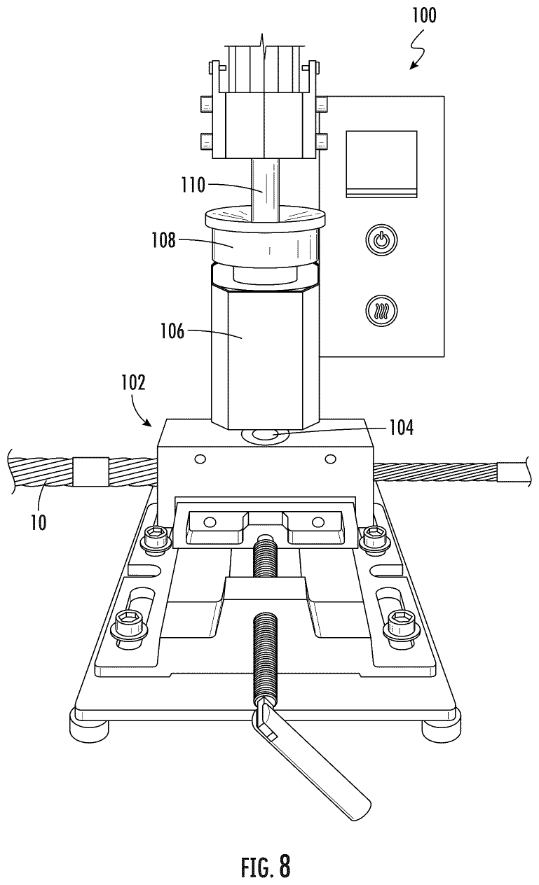

An overmold material having the foregoing properties can be molded to the distribution cable using the system and method described below. FIG. 8 depicts an example of an injection molding system 100 for forming the overmold 52 around the distribution cable 10. As can be seen, the distribution cable 10 extends through a mold 102. Molten polymer overmold material is injected into the mold 102 through an inlet port 104 in the mold 102. The molding system 100 includes an injection barrel 106 fed with overmold material through a hopper 108. A plunger 110 forces the overmold material through the hopper 108 and into the injection barrel 106, where the overmold material is heated to a molten state for injection into the mold 102.

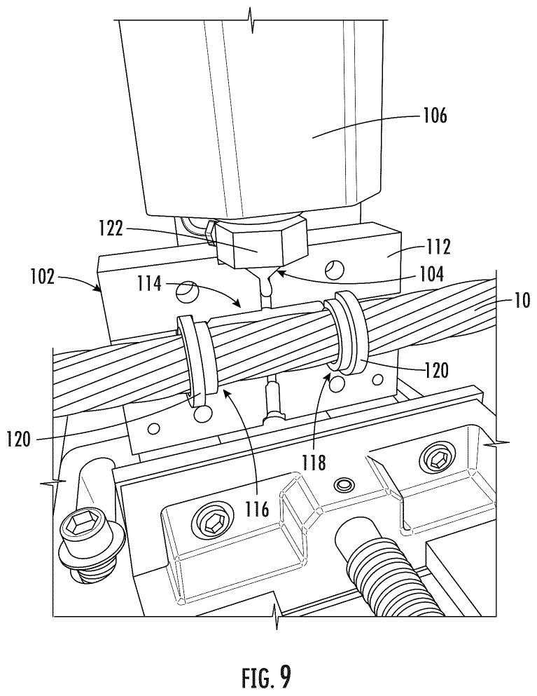

FIG. 9 depicts the injection mold system 100 with one half of the mold 102 removed. As can be seen, the mold 102 includes a first half 112 defining a mold cavity 114. In one or more embodiments, the mold cavity 114 has a generally cylindrical shape with a first diameter in a central region that tapers to a second, smaller diameter at each end. In one or more embodiments, the mold cavity 114 is configured to create an overmold 52 having a thickness of 1 mm to 10 mm, in particular 2 mm to 7 mm, around the distribution cable 10. Such thickness corresponds to half a difference between a maximum cross-sectional dimension of the overmold 52 and a maximum cross-sectional dimension of the distribution cable 10 (at the location of the overmold 52).

The mold cavity 114 has a first end 116 and a second end 118, and the distribution cable 10 extends through the mold cavity 114 from the first end 116 to the second end 118. The mold cavity 114 is sealed at each end 116, 118 with split seal rings 120 that block the molten overmold material from leaking out of the mold cavity 114. The mold cavity 114 is in communication with the inlet port 104. Molten overmold material is injected into the mold 102 through a nozzle 122 in communication with the injection barrel 106.

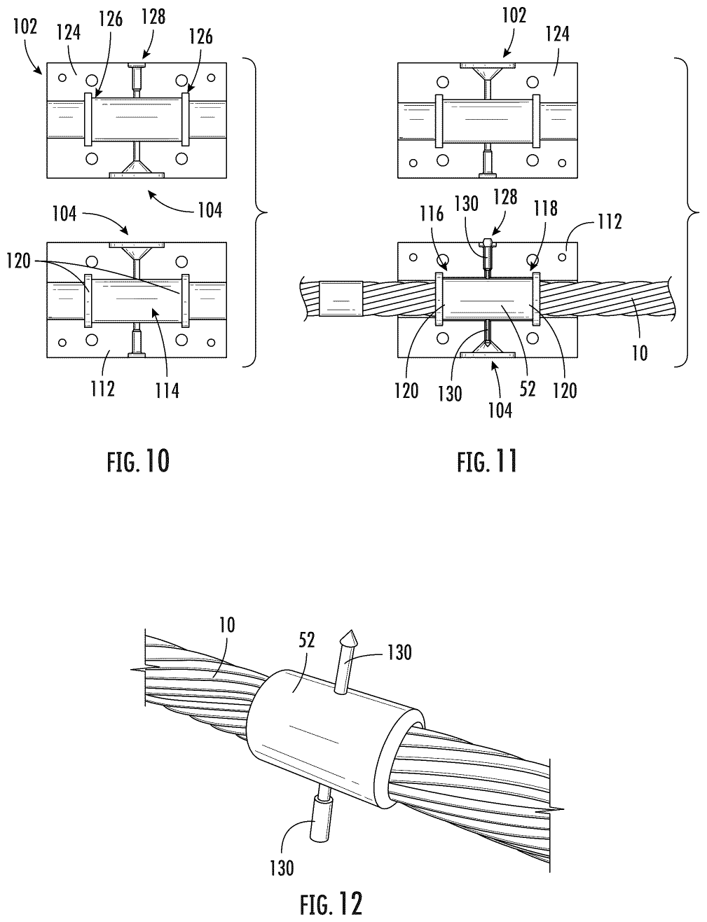

FIG. 10 depicts the halves of the mold 102 including the first half 112 and a second half 124 that mirrors the first half 112 so as to define an opposing half of the mold cavity. As mentioned above, the mold cavity 114 defined by the mold 102 is generally cylindrical with tapers at each end. The mold cavity 114 further defines stepped ring sections 126 configured to accommodate the split seal rings 120. As with the mold cavity 114, each half 112, 124 defines half the first and second stepped ring sections 126. As can further be seen in FIG. 10, the inlet port 104 is frustoconically shaped to engage the nozzle 122 of the injection barrel 106. The mold 102 also includes an outlet port 128 to provide venting of the mold cavity 114 as the overmold material is injected into the mold 102.

FIG. 11 depicts the mold 102 separated after the overmold 52 has been injection molded around the distribution cable 10. As can be seen in FIG. 11, the split seal rings 120 prevent the overmold material from leaking out through the ends 116, 118 of the mold 102, and the overmold material forms runners 130 extending from the inlet port 104 to the overmold 52 and from the over mold 52 to the outlet port 128. FIG. 12 depicts the overmold 52 and runners 130 after the distribution cable 10 has been removed from the mold 102. The runners 130 can be removed with a cutting implement to provide a finished overmold surface.

The embodiment of the mold 102 depicted in FIGS. 8-11 is for an overmold 52 positioned adjacent to a branch point. In such an embodiment, the overmold 52 is substantially uniform in structure. However, for a transition point, the overmold 52 may include a step such that the overmold 52 has a first diameter over the outer layer of subunits and a second diameter over the inner layer of subunits. In one or more embodiments, the transition between diameters of the overmold 52 may be abrupt or tapered. In such embodiments, the mold cavity 114 of the mold 102 would define the tapered or abrupt stepped structure, and split seal rings 120 of different sizes may be used at the opposite ends 116, 118 of the mold cavity 114.

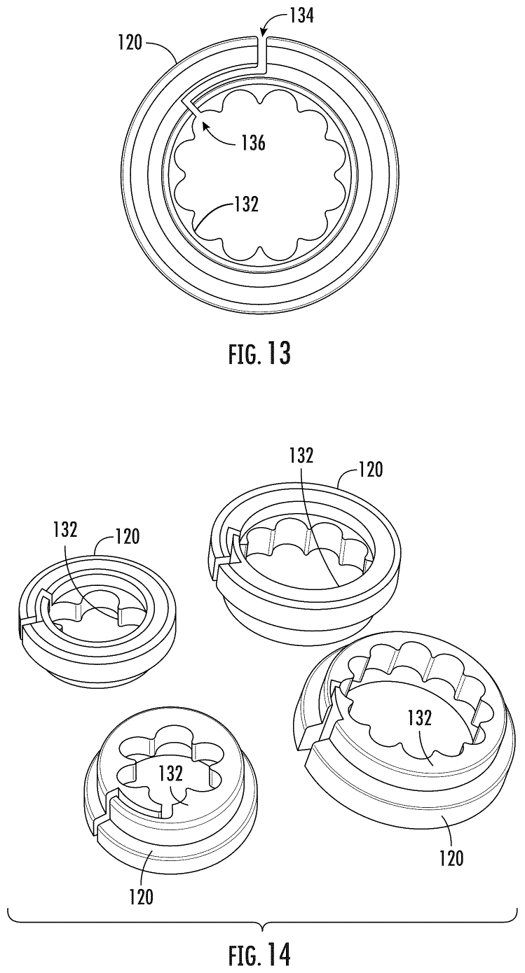

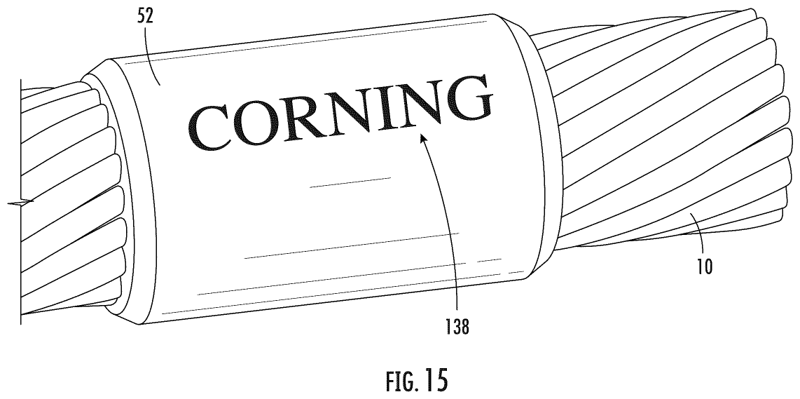

FIG. 13 depicts an example of a split seal ring 120. The split seal ring 120 includes a scalloped inner surface 132 designed to engage the subunits 12 of the distribution cable 10. Thus, the number of scallops on the scalloped inner surface 132 corresponds to the number of subunits 12 in the outermost layer of the distribution cable 10. In this way, the ridges between the scallops of the scalloped inner surface 132 nest within interstices between the subunits 112 of the distribution cable, blocking the flow of overmold material from exiting the ends 116, 118 of the mold cavity 114 of the mold 102. In order to position the split seal rings 120 over the distribution cable 10, the split seal ring 120 has an overlapping structure in which a first break 134 is formed in an outer portion of the split seal ring 120 and in which a second break 136 is formed in an inner portion of the split seal ring 120. In this way, the split seal ring 120 can be separated to be wrapped around the distribution cable 10 to define (along with the mold 102) the width of the overmold 52. In one or more embodiments, the split seal rings 120 are formed from a soft, squishable material that does not bond with the overmold material and that has a higher melting temperature than the overmold material. In such embodiments, the split seal rings 120 may be formed from thermoplastic polyurethane or silicone. FIG. 14 depicts split seal rings 120 of a variety of sizes for placement over distribution cables 10 having different diameters and different numbers of subunits 12 in the outermost layer. Advantageously, the split seal rings 120 can be re-used for multiple molding procedures.

FIG. 15 depicts an example of a finished overmold 52 around a distribution cable 10. The overmold 52 is generally cylindrical with tapered ends, matching the shape of the mold cavity 114. Further, as shown in FIG. 15, the mold cavity 114 may be configured to leave markings 138, such as visual branding language, on the outer surface of the overmold 52. Such markings 138 imprint onto the outer surface of the overmold 52 to indicate the manufacturer or provide relevant performance characteristics or standards of the distribution cable 10 or overmold 52. Advantageously, the incorporation of marking 138 into the molding process avoids the need for an additional step of printing such information on the overmold 52.

According to an experimental example, an overmold 52 was molded around a distribution cable 10, and various thermal, mechanical, and chemical properties of the overmold 52 were determined. The experimental example overmold 52 was configured to bond to subunits 12 having a subunit jacket 32 comprised of polyethylene, in particular comprised of at least 30% by weight of polyethylene. In the particular experimental example described herein, the subunit jackets were made of medium-density polyethylene (MDPE) with a skin layer 38 of high-density polyethylene (HDPE). According to embodiments of the experimental example, the overmold material configured to bond to such predominantly polyethylene subunit jacket materials comprises from 50% to 76% by weight of low-density polyethylene (LDPE) and 50% to 24% by weight of a thermoplastic elastomer (TPE). In such embodiments, the overmold material may further comprise up to 5% by weight of various other additives, such as processing aids, UV stabilizers (e.g., hindered amine light stabilizers or carbon black), colorants (e.g., carbon black), and fungicides, among other possibilities. According to a first example embodiment, the overmold material comprised 70% by weight of LDPE (Dow™ 722, available from The Dow Chemical Company, Midland, MI), 24% by weight of TPE (Infuse™ 9807, available from The Dow Chemical Company, Midland, MI), and 6% by weight of an LDPE-based carbon black masterbatch (DFNA-0037BK, available from The Dow Chemical Company, Midland, MI). In this composition, the final amount of carbon black was about 2.6% to 2.8% by weight.

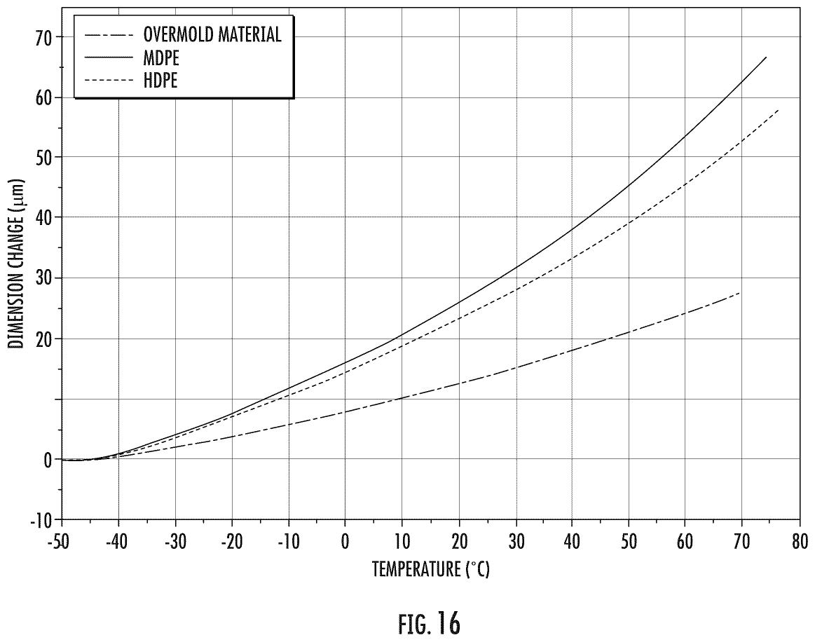

The example overmold material composition had a density in the range of 0.91 to 0.92 g/cm³, a tensile stress at break in the range of 8 to 10 MPa, a tensile strain at break in the range of 500 to 600%, a toughness in the range of 30 to 50 MPa, a melt flow rate in the range of 9.8 to 10.2 g/10 min at 190° C., and a Shore A hardness (instantaneous) in the range of 85 to 88. The coefficient of thermal expansion (CTE) of the example overmold material composition was also determined via thermal mechanical analysis (using a Q400 TMA available from TA Instruments, New Castle, DE). FIG. 16 depicts a graph of the dimension change as a function of temperature between about −50° C. and about 70° C. in which the curves have been normalized at about −45° C. for visual comparison of the curves. As can be seen from FIG. 16, the overmold material has a shallower slope than MDPE and HDPE. Although, the CTE for the overmold material is higher than the CTE for both MDPE and HDPE. The CTE at −40° C., at 25° C., and at 70° C. for the overmold material is 144 ppm/° C., 261 ppm/° C., and 374 ppm/° C., respectively. The CTE for MDPE at these temperatures is 91 ppm/° C., 200 ppm/° C., and 347 ppm/° C., respectively, and the CTE for HDPE at these temperatures is 78 ppm/° C., 174 ppm/° C., and 265 ppm/° C., respectively. However, despite the difference in CTE between the overmold material and MDPE and HDPE, the CTE is within a range of difference (e.g., less than 125 ppm/° C.) that indicates that there should not be any significant dimensional instability during thermal cycling. That is, the overmold material is not expected to delaminate from the subunit jacket based on stresses developed during thermal cycling.

Further, the example overmold material composition was designed to have a glass transition temperature less than −40° C., in particular less than −50° C. In this way, the overmold material composition remains in a rubbery state in typical thermal cycling ranges (e.g., −40° C. to 85° C.), helping the bond between the overmold material and the subunit jacket to remain intact. Additionally, the peak melting temperature was determined to be in the range of 100 to 120° C., which as discussed above allows for the overmold material to be applied to the distribution cable 10 without damaging the subunit jackets.

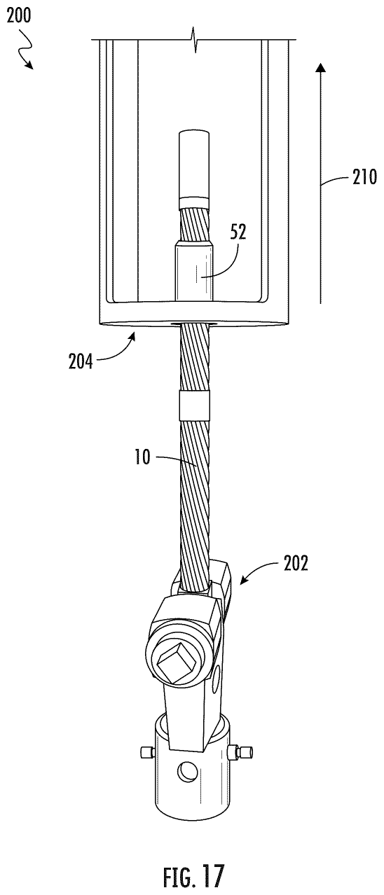

The thermal-mechanical bonding properties of the example overmold composition were tested according to Telcordia GR-3122-CORE. In this regard, the subunit jackets were prepared by wiping them with alcohol to remove any contamination or debris. The example overmold material composition was molded around the outermost layer of subunits of the distribution cable using injection molding system as described above in relation to FIGS. 8-14. Twelve samples were prepared in this manner, and six of those samples were then aged according to Telcordia GR-3122-CORE. The aging process involves three days of thermal aging at 85° C., which is followed by seven days of temperature and humidity cycling from 65° C. and 95% humidity to −40° C. (i.e., the humidity was set at 95% while at 65° C. and left to fluctuate at all other temperatures). The Telcordia GR-3122-CORE aging standard provides information regarding the ability of an overmold material to withstand conditions that can severely damage bonding between the subunit jackets and the overmold material because the deformation and degradation caused by heat and moisture affect the bonding. The twelve samples (six aged and six unaged) were secured in a load frame, and attempts were made to pull the overmold from the subunit jacket. FIG. 17 depicts a sample of the distribution cable 10 secured in a load frame 200. As can be seen in FIG. 17, one end of the distribution cable 10 is secured to fixture 202, and a pulling member 204 is secured below the overmold 52. The pulling member 204 has an aperture wide enough to accommodate the distribution cable 10 but smaller than the diameter of the overmold 52. In this way, when the pulling member 204 is moved away from the fixture 202 (as shown by arrow 210), stress is applied to the overmold 52 to attempt to strip the overmold 52 from the subunits 12 of the distribution cable 10.

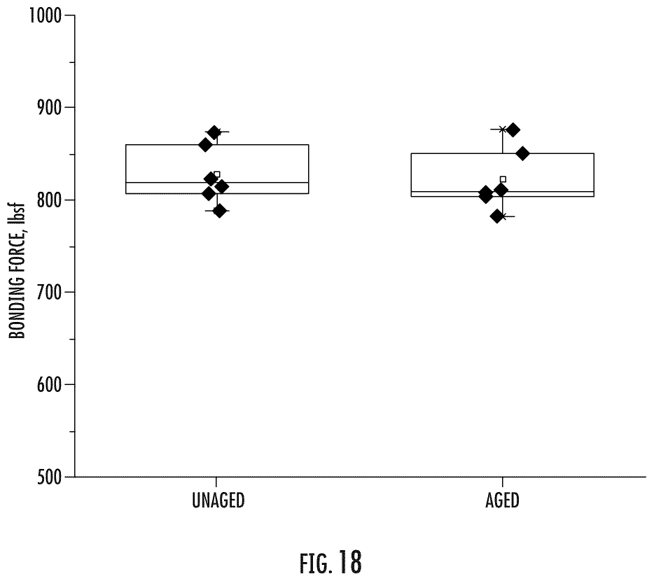

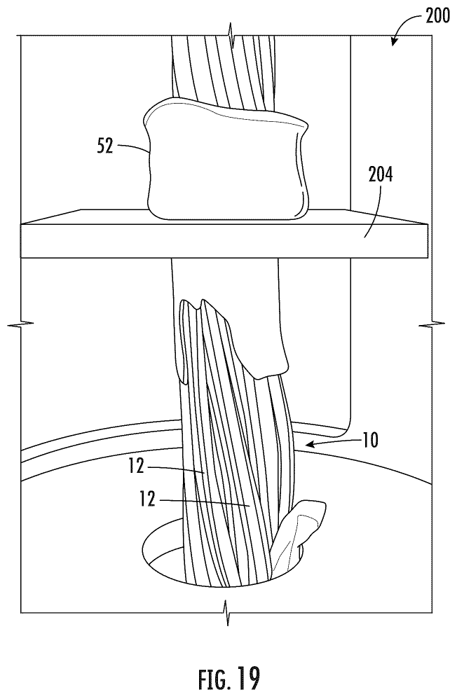

FIG. 18 depicts the force (lbsf) required for the overmold 52 or distribution cable 10 to fail as a result of the loading applied by the load frame 200. FIG. 18 provides the force for both the aged and unaged samples. As can be seen in FIG. 18, the force required to cause failure is above 800 lbsf for both the aged and unaged samples. Thus, a further advantage of the overmold material composition is that it is substantially unaffected by aging conditions. In one or more embodiments, the bonding force as measured according to the described tensile loading procedure is at least 600 lbsf, at least 700 lbsf, or at least 800 lbsf, including after aging. FIG. 19 depicts a sample of the distribution cable 10 after having undergone loading on the load frame 200. As can be seen, the overmold 52 has remained substantially in place, and it was observed by the application that the jackets of the subunits 12 failed in some instances before the overmold 52.

According to a second example embodiment, the overmold material comprised 60% by weight of LDPE (AXELERON™ CX 1258 NT, available from The Dow Chemical Company, Midland, MI), 34% by weight of TPE (Infuse™ 9817, available from The Dow Chemical Company, Midland, MI), and 6% by weight of an LDPE-based carbon black masterbatch (DFNA-0037BK). While carbon black was used as the UV stabilizer in this and the previous examples, other UV stabilizers such as hindered amine light stabilizers could also be used. Further, the composition can contain up to 5% by weight of various other additives, such as processing aids, colorants, and fungicides, among other possibilities. The second example embodiment of the overmold material is also intended to work with any jacket material containing at least 30% by weight of polyethylene (including, for example, an MDPE jacket and/or HDPE skin layer). Such an overmold material is expected to have properties similar to those described above with respect to the first example embodiment.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber distribution cable, comprising:
a central member extending along a longitudinal axis of the optical fiber distribution cable;
a plurality of subunits stranded around the central member in at least one layer, the at least one layer comprising an outermost layer of subunits; and
an overmold formed around the outermost layer of subunits adjacent to a branch point, the overmold comprising a thermoplastic material;
wherein each subunit of the plurality of subunits comprises a subunit jacket;
wherein subunit jackets of the outermost layer of subunits define an outermost surface of the optical fiber distribution cable;
wherein a first subunit branches away from the optical fiber distribution cable at the branch point;
wherein the thermoplastic material of the overmold comprises a first melting temperature at least 10° C. less than a second melting temperature of the subunit jackets; and
wherein a bonding force between the overmold and the subunit jackets of the outermost layer of subunits is at least 600 lbsf.

2. The optical fiber distribution cable of claim 1, wherein the subunit jackets predominantly comprise a medium-density or high-density polyethylene and wherein the thermoplastic material comprises 50% to 76% by weight of low-density polyethylene and 50% to 24% of a thermoplastic elastomer.

3. The optical fiber distribution cable of claim 2, wherein the thermoplastic material further comprises up to 3% by weight of a UV stabilizer.

4. The optical fiber distribution cable of claim 1, wherein the thermoplastic material of the overmold comprises an elastic modulus in a range from 70 MPa to 250 MPa and a hardness in a range from 60 to 95 Shore A.

5. The optical fiber distribution cable of claim 1, wherein the thermoplastic material comprises a melt flow rate of at least 4 g/10 min at 190° C.

6. The optical fiber distribution cable of claim 1, wherein the bonding force is at least 600 lbsf after aging according to GR-3122-CORE.

7. The optical fiber distribution cable of claim 1, wherein the plurality of subunits comprises at least one optical fiber subunit and at least one electrical conductor subunit, wherein each of the at least one optical fiber subunit comprises one or more optical fibers disposed within the subunit jackets, and wherein each of the at least one electrical conductor subunit comprises one or more electrical conductor cores disposed within the subunit jackets.

8. The optical fiber distribution cable of claim 1, wherein the at least one layer comprises a first layer stranded around and contacting the central member and a second layer stranded around and contacting the first layer and wherein the optical fiber distribution cable further comprises a further overmold at a location wherein the second layer transitions to the first layer, the further overmold comprising the thermoplastic material.

9. The optical fiber distribution cable of claim 1, wherein the thermoplastic material comprises a glass transition temperature that is less than −40° C.

10. A method of forming an overmold over an optical fiber distribution cable, the optical fiber distribution cable comprising an outer layer of subunits as an outermost surface of the optical fiber distribution cable, the method comprising:
positioning the optical fiber distribution cable in a mold adjacent to a location at which at least one subunit of the outer layer of subunits branches from the optical fiber distribution cable, the mold comprising a cavity around the distribution cable and an inlet in fluid communication with the cavity; and
injecting a thermoplastic material into the cavity through the inlet, the thermoplastic material comprising a first melting temperature that is at least 10° C. less than a second melting temperature of subunit jackets of the outer layer of subunits and a bonding force with the subunit jackets of the outer layer that is at least 600 lbsf.

11. The method of claim 10, further comprising wrapping two split ring seals around the distribution cable prior to positioning, wherein, prior to or during positioning, the split ring seals are separated by a distance corresponding to a width of the cavity of the mold and wherein the split ring seals prevent the thermoplastic material from leaking out lateral ends of the cavity.

12. The method of claim 11, wherein the split ring seals comprise scalloped interior surfaces configured to engage the outer layer of subunits.

13. The method of claim 10, wherein the subunit jackets predominantly comprise at least 30% by weight of a polyethylene and wherein the thermoplastic material comprises 50% to 76% by weight of low-density polyethylene and 50% to 24% of a thermoplastic elastomer.

14. The method of claim 13, wherein the thermoplastic material further comprises up to 3% by weight of a UV stabilizer.

15. The method of claim 10, wherein the thermoplastic material of the overmold comprises an elastic modulus in a range from 70 MPa to 250 MPa and a hardness in a range from 60 to 95 Shore A.

16. The method of claim 10, wherein the thermoplastic material comprises a melt flow rate of at least 4 g/10 min at 190° C.

17. A mold for injection molding an overmold of an optical fiber distribution cable, the mold comprising:
a first mold half comprising a first half of a mold cavity, a first half of a first stepped ring section at one end of the first half of the mold cavity, and a first half of a second stepped ring section at an opposing end of the first half of the mold cavity;
a second mold half comprising a second half of the mold cavity, a second half of the first stepped ring section at one end of the second half of the mold cavity, and a second half of the second stepped ring section at the opposing end of the second half of the mold cavity;
a first split seal ring comprising a first scalloped inner surface configured to engage an outer layer of subunits of the optical fiber distribution cable, the first split seal ring configured to be seated in the first stepped ring section; and
a second split seal ring comprising a second scalloped inner surface configured to engage the outer layer of subunits of the optical fiber distribution cable, the second split seal ring configured to be seated in the second stepped ring section.

18. The mold of claim 17, wherein the first split seal ring and the second split seal ring each comprise silicone or thermoplastic urethane.

19. The mold of claim 17, the first mold half and the second mold half together define an inlet configured to receive molten thermoplastic material from an injection molding nozzle.

20. The mold of claim 17, the mold cavity defines a first diameter of the overmold in a central region and a second, smaller diameter of the overmold at the ends.
